(19) United States
(12) Patent Application Publication
(10) Pub. No.: US 2007/0188983 A1
(43) Pub. Date: Aug. 16, 2007

(54) Device to ensure safety of storage, transfer, transport and handling of dangerous, combustible, oxidizing, corrosive, toxic and/or polluting products

(76) Inventor: Bertrand Des Clers, Paris (FR)

Correspondence Address: FULBRIGHT & JAWORSKI, LLP, 666 FIFTH AVE, NEW YORK, NY, 10103-3198, US

(21) Appl. No.: 10/594,342

(22) PCT Filed: Mar. 24, 2005
(86) PCT No.: PCT/FR05/50193

§ 371 Date: Sep. 25, 2006

(30) Foreign Application Priority Data
Mar. 25, 2004 (FR) 04/50595

(51) Int. Cl. H02B 1/00

(52) U.S. Cl. 361/600

(57) ABSTRACT

The invention relates to a device which enables to ensure or improve considerably the safety of storage, transfer, transport and handling of dangerous and/or potentially reactive products (206), under an industrial scale environment, at essentially atmospheric temperatures and pressures. The inherent danger of such products induce the risk of large-scale, unexpected and sometimes unexplained fires/explosions, and their massive spill out result in environmental pollution and sometimes toxic emissions. The inventive device introduces the principle of danger evaluation and of redundant levels of safety components and interventions aimed at keeping the risk of accident under control. In the particular embodiment concerning fuel gases-vapours, where fire/explosion can only occur in the presence of an oxidizer such as atmospheric oxygen, the device ensures that the fuel is prevented from remaining in contact or mixed with atmospheric air for instance, and prevents massive fuel spill out if the reservoir structure is ruptured following accidental impact or exposure to the heat of a surrounding fire.

### CROSS-REFERENCE TO RELATED APPLICATIONS

This application is a §371 from PCT/FR2005/050193 filed Mar. 24, 2005, which claims priority from FR 04/50595 filed Mar. 25, 2004, each of which is herein incorporated by reference in its entirety.

### TECHNICAL FIELD

The present invention refers to a device destined to prevent major accidental fires/explosions, to ensure safety of storage, transfer, transportation and handling of hazardous products, especially of fuels/combustible materials of which the gases and vapors, put into contact or mixed with atmospheric air, present a danger of spontaneous ignition of the explosive atmosphere thus created. It further enables, in the event of an accident causing the rupture of the confinement/reservoir structure, or the ripping out of its connections, to prevent or to considerably reduce the risks of massive accidental spillage of the contained product into the ambient environment, such spillages being the cause of major fires/explosions and dangerous pollutions.

The embodiments of the invention in the quoted industrial domains aim at controlling danger by eliminating the risk at its source, i.e. for fuels/combustible materials, by preventing the oxygen in the air from entering and remaining in contact with them or getting mixed with their vapors/gases. The other embodiments enable to ensure that these dangerous products are protected at several containment safety levels, eliminating or considerably reducing the risks of their massive spillage into the environment.

Unfortunately, major industrial accidents where fire and/or explosion of large volumes of fuels (gases or vapors) are implicated, in addition to the massive spillage of flammable, polluting and/or toxic products, in the surroundings, continue to occur, causing not only important material damage and loss of jobs, but also loss of lives. Prior art has been unable to give advance warning, prevent or explain those accidents.

### BACKGROUND OF THE INVENTION

In terms of fire safety, the appearance of a flame is governed by a Creed called the “Fire Triangle”, drawn up from thermo chemical laboratory experiments, which set flammability limits outside of which the fuel or the mixing of its vapors with the air's oxygen are not flammable. Furthermore, this creed requires the existence of an ignition source to provide the explosive atmosphere with certain minimum ignition energy (MIE) to initiate the fire startup (matchstick, spark, hot spot). Research in the areas of chemical kinetics, thermodynamics and fluid mechanics carried out and validated experimentally over the past decades, has demonstrated that the “Fire Triangle” was too simplistic an approach, incapable of predicting or explaining certain major industrial fires or explosions.

The prior art requires suppliers of flammable gases and dangerous products delivered to laboratories to label them, giving the exact composition of the product delivered, specifying the nature and percentage of impurities mixed with the product, as well as the expiry date beyond which the product should no longer be used but sent back to the supplier. For reasons of economy, these measures and precautions are rarely applied to industrial usage situations.

To prevent the massive spillage of a dangerous/polluting/flammable product, the design of the industrial confinements destined for their storage, transfer, transportation and handling have proved to be inadequate in the event of accidental rupturing of such structures, generally made of sheet metal or to that of metallic piping/connections which are not sufficiently resistant to impact, breakage or to corrosion over time.

The prior art formally admitted, a long time ago, that: “Without oxygen, flames are impossible!” But, having said that, the simple rule of excluding oxygen in those industrial situations where the major accidents mentioned have occurred has never been applied. On the contrary, on every occasion, one was confronted with the presence of an explosive atmosphere containing oxygen, such as defined below.

It should be reminded here that, according to European Legislation, “explosive atmosphere” means: “a mixture with air, under atmospheric conditions, of flammable substances in the form of gases, vapors, mists or dusts in which, after ignition has occurred, combustion spreads to the entire unburned mixture”.

The prior art has, furthermore, established standards based upon experimentation in the laboratory, defining the “limits of flammability” of an “explosive atmosphere” outside of which the fuel-gas/vapor mixture cannot ignite, as well as what must be the “minimum ignition energy” that, for instance, a spark must provide, below which there is no danger of a fire startup. It has however been demonstrated that industrial atmospheres do ignite and burn outside of those limits, and that the energy to be provided by an ignition source tends exponentially towards zero at relatively low temperatures, thus leading to a false feeling of safety.

Risks can and must be eliminated at the source, by holding fuel from contact with air.

The risk of massive spillage of fuels or toxic and/or polluting products into the environment is real and gives rise to major accidents every year.

The prior art, although defining the “explosive atmosphere”, omitted to highlight that these were mixtures intrinsically at risk, in which auto-oxidation reactions take place, even at the lowest temperatures, and the vocation of which is to ignite quasi-spontaneously after an induction period of shorter or longer duration, whereas, according to the creed used as a basis for current standards, the ignition of a fuel, in contact with ambient air, under atmospheric pressure and temperature, requires necessarily an outside source of ignition (energy input).

The prior art does not either take into account the chemical kinetics modelling studies of combustible mixtures, which have shown the reality of occurrence of their spontaneous ignition following a runaway of some chain-branching reactions (after a finite induction period, all the shorter as the mixture's temperature is high), nor does it take into account the exponential decrease towards zero of the “minimal ignition energy” required, even at common industrial temperatures, nor the experimental studies which have shown that explosive atmospheres burn even when they only contain a fraction of 1% of oxygen or when their temperature is as low as minus 150 degrees Celsius.

Flammability limits are based on standardized laboratory methods, are often strongly dependent on wall effects—heat transfer (conduction, convection), catalysis, O2 and H2 adsorption neutralization of free radicals—which are often negligible in industrial dimensions.

In the case of a pre-mixed fuel-oxidant mixture, one neglects all heredity consequences, as well as the common presence of impurities or of products due to auto-oxidation capable of acting as catalysts/oxidizers.

Failure to provide an explanation regarding fires/explosions which have occurred upon simple contact or mixture of fuel and air in almost atmospheric conditions, meticulous investigations having been unable to identify the slightest presence of an outside energy input, no measure aimed at adequately warning about this type of risk have been taken, so that new accidents seem inevitable in the future.

The prior art has been unable to resolve this state of affairs.

For dangerous products which risk to ignite/explode upon contact with the air or to pollute the environment if they are massively spilled:

Major unforeseen accidents, involving the spillage of petroleum and/or chemical, toxic and/or polluting products in populated or residential areas, in the atmosphere, the sea, rivers or on land, unfortunately occur frequently.

Although it is not possible to completely eliminate all accidental risk of impact or structural failure with regard to a reservoir/fuel-storage tank/gas-pipeline or its connections, the Device according to the invention, enables, on the other hand, as explained below, to considerably improve the confinement safety of such dangerous products by ensuring that the product is properly retained inside a Device due to a succession of protection levels corresponding to the identified risks, thus eliminating them at the source.

### BRIEF SUMMARY OF THE INVENTION

The subject of the invention is to overcome these two major risks.

It has been illustrated above that, under certain industrial situations, there exists a real danger of self-ignition for any explosive atmosphere made up of a fuel-oxidant mixture of vapours and/or gases, even far outside the currently admitted flammability limits. If the oxidant, especially represented by atmospheric oxygen, is prevented from coming into contact and/or being mixed with the fuel, the latter no longer constitutes a hazard as is it will not become a component of an explosive atmosphere.

Furthermore, the accident data bases demonstrate that many major accidents are due to the structural failure of reservoirs, gas pipelines or classical fuel tanks and to the massive spillage of the product contained therein into their environment, especially into the ambient air.

The object of the invention is thus a Device which, in the first instance, prevents the hazardous formation of an explosive atmosphere by imposing and maintaining a physical separation between the fuel contained within and the air, in all circumstances; should the Device detect the possible presence of an oxidizer in contact or mixed with the fuel vapors-gases, it will activate the necessary means to inform the operator and to neutralize the danger.

The means of the Device, which are aimed at preventing air intake into the containers, can be used to prevent leakage/spillage of the product contained within by activating a succession of protection/confinement levels making it possible to avoid, in the event of accidental rupture of the confinement structure (reservoir), its massive spillage into the environment.

In order to eliminate at the source the risks caused by the hazard indicated earlier, the first measure consists of:

1.—controlling the stability of the product,

2.—avoiding all contact or product mixture with air or the ambient oxygen,

3.—if the wrong has already been done, then separate them and stabilize the product as quickly as possible,

4.—if the physical separation of the mixture proves to be impossible within the necessary time and conditions, take the needed measures to neutralize the mixture, especially by chemical means, or to burn it under controlled conditions, without danger.

The Device described below has the means to control on an ongoing basis the fuel's stability during its lifetime, to detect any abnormal feature, to measure the physical and chemical parameters required and their evolution over time, to evacuate the impurities and dangerous by-products contained within it, and to activate the necessary means to eliminate the identified hazard.

The invention refers to, in a general manner, a safety/confinement Device for dangerous and/or potentially-reactive products during their storage, transportation or handling in an environment of industrial dimensions at essentially atmospheric pressure and temperature, this product being contained in a reservoir and the said device being characterised in that it comprises an envelope 202 within the reservoir, such envelope being designed to prevent the product from coming in contact with any atmospheric oxygen, even in the event of structural rupturing of the reservoir.

In an embodiment, the Device comprises means to delay or prevent spillage of the product out into the atmosphere, especially in the event of accidental impact or unforeseen heat exposure from a neighbouring fire.

According to an embodiment, the Device includes at least one sorption, or dissolution or diffusion selective permeable membrane to enable the extraction of potentially-hazardous vapors and gases contained in at least one element of the device.

According to an embodiment, the Device comprises at least one selective permeable membrane to enable injection of an inhibitor/stabilizer into the product or into its vapors, or an inert gas used to flush out and/or ventilate the ullages of the reservoir, and of the other elements, especially for storage, of this device.

According to an embodiment, the Device comprises means for generating and for injecting into the reservoir, around an envelope containing the product and/or around at least one inflatable cushion of the “airbag” type or around another element, retardant foam, self-solidifying or not, incombustible and inert with regard to the stored product, destined to contribute towards the leakproof capacity and the protection of the envelope, by physically and thermally protecting the product from the walls and from the surroundings.

According to an embodiment, the Device comprises at least one safety valve controlling the product inlet and/or outlet from an element of the device or the entry of ambient air in the event of failure of the distribution circuit or rupture of its outside connection, particularly after impact.

According to an embodiment, the Device comprises an element equipped with at least one mechanism located at one of the inlets and/or the outlets of an envelope containing the stored product for the purpose of sealing off the orifices of the envelope, as well as those of the inflatable cushion of the “airbag” type which encloses it, while separating them from the reservoir's walls.

In an embodiment at least one of the elements containing the product consists of non-permeable envelope, deformable or not, containing the product.

In such a case, the envelope in which is contained the dangerous product is, for example, an element which displays at least one of the characteristics chosen from the group comprising:

exhibiting a non-permeable and a chemical inertness, especially in relation to the stored product, to its vapours and to the by-products of its self-reactivity, decomposition and/or degradation, to the chemical or biological impurities which it might contain, to air or to another ambient reactant, the envelope preferably including for this purpose one or several layers made up of materials of varying permeability,

having a mechanical resistance, in the event of impact, to perforation and/or to tearing, for example comprised of two or more layers of materials in which are eventually incorporated mesh or fibers of “nylon”, glass, carbon or “Kevlar”, metallic and/or synthetic, woven or not,

holding a tolerance to temperatures varying from minus 50 degrees Celsius to plus 900 degrees Celsius, preferably from minus 50 to plus 150 degrees Celsius, and

exhibiting a strong longevity to exposure to solar radiation, especially for cases where the envelope is exposed for long periods, for example when containing a product stored in bulk.

In an embodiment, the Device includes micro and/or nano sensors to detect the envelope's condition and characteristics, especially of the autonomous type, wireless or connected, for example via fibre optics to a control center, for monitoring and activating means for the device to intervene.

In an embodiment, the envelope is itself completely enclosed by at least one inflatable watertight cushion of the “airbag” type.

In an embodiment, the inflating of at least one element of the “airbag” type, at the time of its activation, is ensured with an inert and incombustible gas, such as nitrogen or argon for fuels, especially non-reactive in relation to the stored product and to its decomposition by-products.

In an embodiment, the Device comprises means to control the stability and/or the initial reactivity of the product, to ensure permanent monitoring of its danger level, especially its composition, its age, its aging rate and such parameters as its temperature and the concentration of the most significant reactants, in order to activate, manually or automatically, based upon predetermined values, alarm and intervention means, such means of intervention particularly enabling to correct, as necessary, the physical or chemical parameters required to prevent an uncontrollable reactive runaway.

In an embodiment, the reactive or dangerous product under containment includes at least one of the products chosen from the group comprising: fuels, especially hydrocarbons, carbohydrates and hydrogen, organic materials, oxidizers, especially oxygen and peroxides, chemical substances likely to ignite/explode spontaneously when coming in contact with the ambient air, as well as toxic and/or polluting products with regard to the environment.

In an embodiment, the Device comprises means to ensure several levels of confinement adapted to the product or to the risks of accidental aggressions linked to the environment or to the conditions of use, such means preferably including the successive elements surrounding an envelope containing the product, the walls of which each provide an additional level of chemical, physical, thermal and/or mechanical protection to the dangerous product contained within, beyond the envelope itself.

In an embodiment, the Device includes at least one detector and/or a sensor, and/or a detector that is part of a microcomputer, having the task of transmitting data to a central processing unit or to a control center, especially via wireless transmission and/or via fibre optics.

In an embodiment, the Device includes means of intervention capable of being activated in accordance with the data transmitted by the detectors or sensors, and/or the sensors that are a part of a microcomputer, in order to react and overcome the risks incurred.

In an embodiment, the Device includes at least one means for collecting gases, reactive and/or toxic products, flammable vapours of a dangerous, toxic and/or polluting nature, extracted from an element of the device, especially from the envelope, in order to temporarily store them safely, to condense, recycle or neutralize them, should there be a risk of their self-ignition or explosion or accidental release into the environment.

According to an embodiment, the envelope has at least one high point so that the bubbles, the vapors or the gases present in the stored product may tend to accumulate in such a high point.

According to an embodiment, the Device includes means for evacuating gases and/or the accumulated vapors, especially in a high point of an envelope or of a product transfer/distribution element, in order to, for example, collect them, direct them to a safe storage, stabilise them, neutralise or burn them in a controlled manner, for example in an engine or a flare, or to inject them back into the product or into a distribution circuit.

According to an embodiment, the Device comprises means for carrying out at least one of the following operations:

monitor the product temperature and compare it with at least one value set by the operator,

cool off the product down to the prescribed level in order to to ensure the safety margin needed in relation to the ambient risk of an accidental energy input exceeding the value needed for its self-ignition/explosion,

control stability of the product,

detect the presence of hazardous vapours, especially flammable and/or explosive, in the elements of the device located outside an envelope containing the product, and evaluate their danger relative to their temperature and their concentration, as well as with those of the oxygen and/or other reactants,

compare the measured values with the pre-determined values in order the open or to close at least one valve or one gate and/or to particularly activate means for filling/emptying, for inflating, for flushing out, for ventilating, for injecting neutralising products, for cooling off and for collecting.

According to an embodiment, the Device comprises means for carrying out at least one of the following operations:

detecting an impact,

identifying a leakage of the product contained in an envelope,

detecting and measuring an increase in the temperature of the product, and/or of the walls of the reservoir and of those of (an)other element(s) of the device,

monitoring of the product's storage period and conditions, and comparing the said period with a deadline possibly prescribed by the operator,

evaluating its level and/or its rate of aging.

According to an embodiment, the Device comprises at least one sensor such as piezoelectric fibres incorporated in the wall of a component of the “airbag” type, and means such as activating a valve, in order to prevent the “airbag” type component from inflating to an excessively high pressure in relation to the specifications of the reservoir's structures, and then preventing it from deflating once the desired volume has been reached in order to ensure optimal protection of an envelope containing the product as well as of the product stored.

The invention also concerns application of the device described above to a land, air, space, maritime or river vehicle.

The invention further concerns application of the device described above to storage, to transfer, to transportation and to handling bulk products, wrapped or not, and/or in an open space, or a confined or semi-confined reservoir.

The invention also concerns application of the device described above to storage, to transfer, to transportation or to handling a product that is in gas or liquid form, especially vapors, mist, droplets, or of solids, for example as particles, grains, granules, powder, dust, flour, chips, fibers, sheets or porous material.

### BRIEF DESCRIPTION OF THE DRAWINGS

Some of the Device's embodiments are illustrated and described below, as examples and non-exhaustive, using the enclosed diagrams on which:

FIG. 1 shows an embodiment of the Device and its usage to secure large capacity road or rail transportation mobile means, such as trailers of tanker trucks or railroad tank cars;

FIG. 2 shows the elements of the device according to the invention for the delivery of fuel to an underground tank, as well as for its transfer for refueling a large capacity aircraft via a transport vehicle;

FIG. 3 shows the elements of the Device for eliminating hazards on the ground and in flight as shown in certain large reservoirs of transport category aircraft currently operated in the fleets of many airlines and by the armed air forces; and

FIG. 4 shows a detailed image of an embodiment of a component of the Device linked to an envelope with a high point according to the invention.

### DETAILED DESCRIPTION OF THE EMBODIMENTS

It is reminded that some of the aims of the Device are:

1. To avoid all contact or mixture of the air with the fuel or with its vapours, whether this be during storage, transfer, transportation or regular handling, which would result in the formation of an explosive atmosphere pocket inside the device.

2. Detect the accidental introduction of air (oxygen) into the Device, triggering off the alarm and activation of the automatic or manual safety means, enabling the operator to resolve the problem.

3. To avoid that, at any time, the product/fuel temperature from increasing up to a level equivalent to or exceeding the product's flash point and its fire point, in which case its accidental contact (or that of its vapours) with the ambient air, could result in a quasi-instantaneous ignition/explosion; such extremely hazardous conditions correspond to common temperatures in industrial environments for which the minimum ignition energy and the induction period of the explosive atmosphere prior to spontaneous ignition approach zero; accidental product leakages may occur during loading or when emptying the Device.

Avoid any accidental spillage of the stored product out into the environment (zero effluent policy) as a result of an accident provoking structural rupture of the traditional confinement system, especially a direct impact or a fire surrounding the Device.

Only certain elements/components of the Device shall be singularly described below, as they relate to innovations in relation to the current confinement/fire-safety techniques.

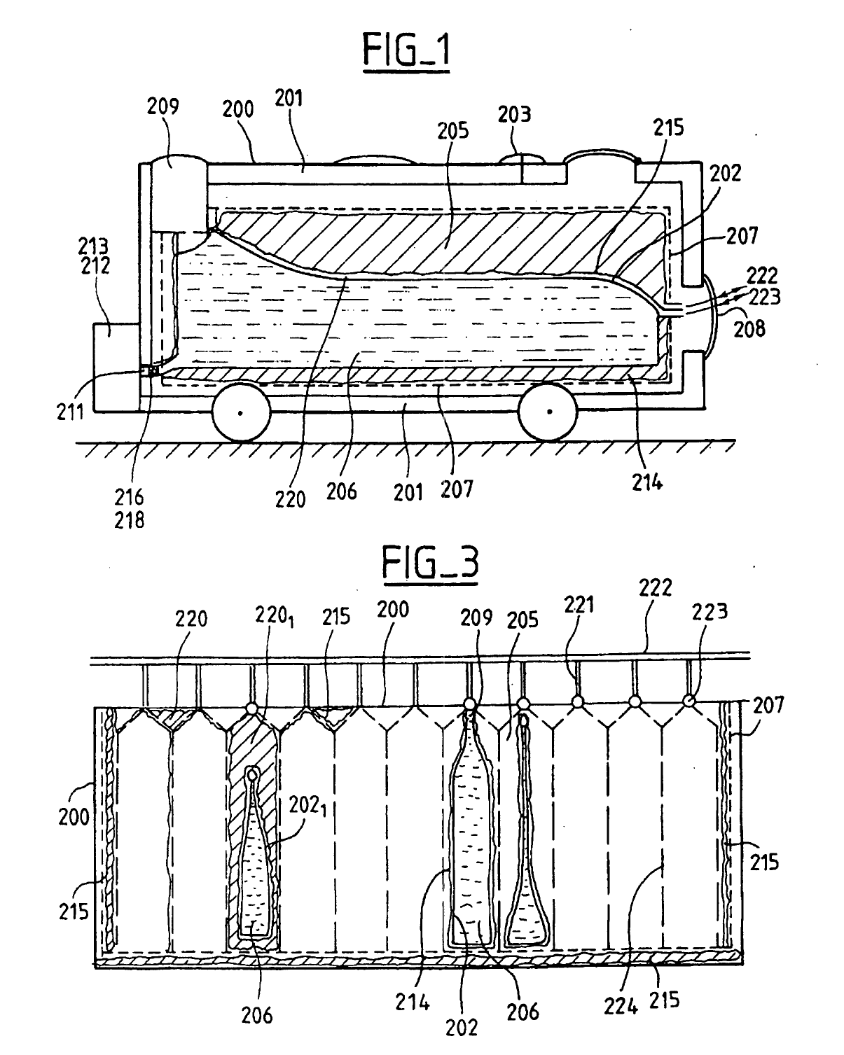

FIG. 1: Railroad Tank Car/Tanker Truck

The various elements of the Device illustrated in FIG. 1 of a railroad tank car/tanker truck are as follows:

200: rail tank car/trailer truck.

201: thermal insulation.

202: non-permeable envelope for the confinement of the dangerous product (see comments below).

203: inert gas inlet/outlet valve.

205/214: inert gas filling the airbag.

206: fuel.

207: cradle, ceiling and perforated walls to support and insulate the envelope and the airbag(s); it must be noted that this cradle may itself be completely or locally protected by a second airbag, not illustrated, should the risk level warrant such action.

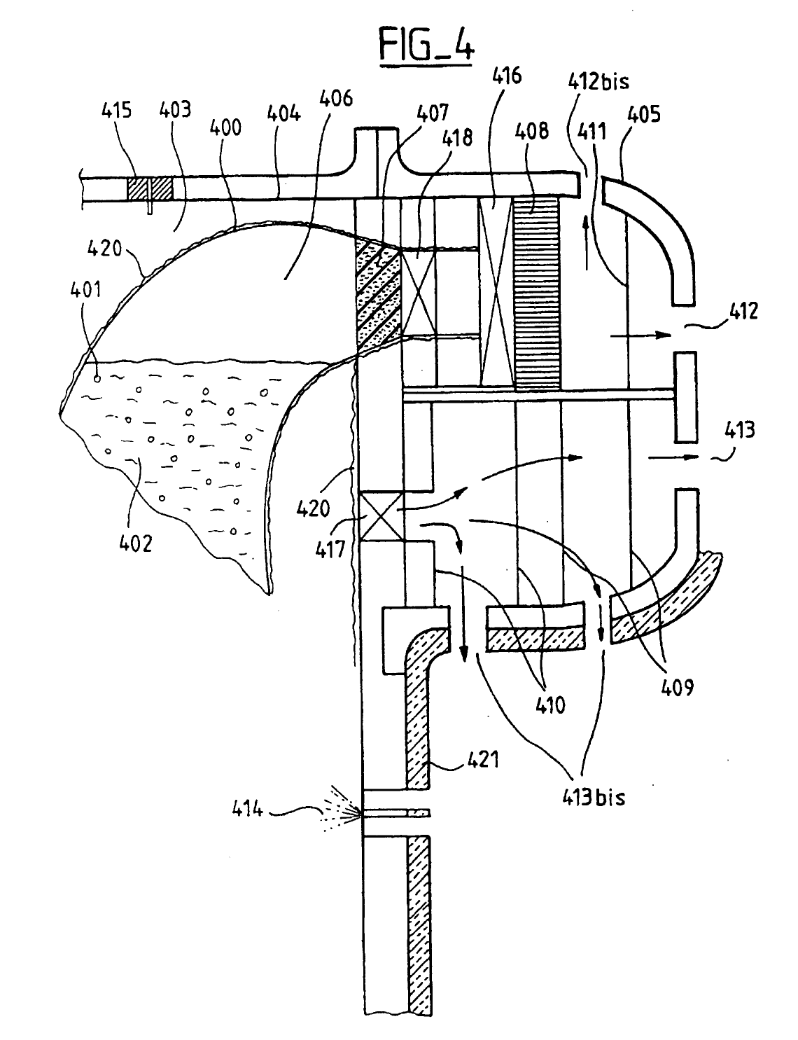

209: “Bubble” situated at the high point (see details in FIG. 4)

211: inlet/outlet fuel/product orifice.

212/213: means for control, washing, cleaning, filtering, stabilizing and fuel cooling; for dangerous products in general, their stability and conformity with the prescriptions must always be checked and restored as needed by the operator prior to loading.

215: inflatable envelope of the airbag type which encloses the envelope.

216-218: closing valves for the envelope's inlet/outlet orifices; these valves are supplemented by the programmed closing valves for the airbag and, in the case of some embodiments, there exists a cutting off mechanism to separate the envelope and the airbag which encloses it from the fuel tank's wall and from the inlet and product fill-up connections 211.

220: interstitial inert gas between the envelope and the airbag.

222: inlet and outlet orifices for the airbag inflating gas.

223: inert gas inlet and outlet orifice.

In order to correctly fulfill its role, envelope 202 is non-permeable and chemically inert in relation to the product that it contains, as well as to the air, to oxygen or other oxidizers or corrosive products existing in atmosphere 220 at the outside of the envelope, in the reservoir's ullage.

To that end, various types or combinations of materials, synthetic or natural, can be made up to manufacture the envelope. According to an example, a thick polyethylene film is particularly adapted for the embodiment of the invention in terms of the bulk storage (not illustrated) of such solid fuels as flour, powders and/or granules, and especially of active carbon. In this embodiment of the invention, the envelope may take the form of a flexible and deformable lid, fixed hermetically to the walls of the confined or semi-confined space, or to the ground in the case of bulk storage without lateral walls, completely covering over the combustible material (fuel) to prevent any outside air from penetrating into the stored product.

Other composite materials, especially of nitrile, neoprene, urethane, elastomers and/or plastomers, in a single layer or in the form of multi-layered material, are used according to the type of product stored and the mechanical, chemical or thermal resistance expected from the envelope.

According to a second characteristic, envelope 202 must, in certain cases, be deformable, especially through its flexible, elastic and/or pre-folded design, in order to increase in volume to house product 206 during its loading via the valves 216-218 up to the prescribed capacity for the reservoir. The envelope should be able to be emptied by completely flattening it out once the fuel has been entirely evacuated, unless the space thus freed is gradually filled with inert gas through orifice 223 coming from a temporary storage. In certain cases, the injection of an inert liquid, non-mixable with the stored product, may be considered in order to fill up or to empty the envelope via orifice 211, while the stored product is being extracted or loaded.

When the stored/transported product in such a tank/envelope is a fuel, if one wants to avoid all risk of formation of an explosive atmosphere, the “empty” fuel tank must be filled permanently and in advance with such inert gas as nitrogen or carbon dioxide in particular; such gas can be collected in a temporary storage container as the envelope is being filled up with the aim of it being used again at the time of unloading. This is achieved by using a pump, a gate, a valve, all governed by different sensors and systems, not illustrated.

Similarly, the sensors which monitor the prescribed chemical and physical parameters and will activate the alarms and means of intervention in the event of anomalous features or detection of danger, are not illustrated.

If, following an accident, the device's sensors detect a high increase in the fuel tank's wall temperature and/or that of the envelope, especially due to the presence of flames in the immediate neighbourhood, generators of retardant foam will be activated in order to provide an additional thermal protection level for the product contained in the envelope.

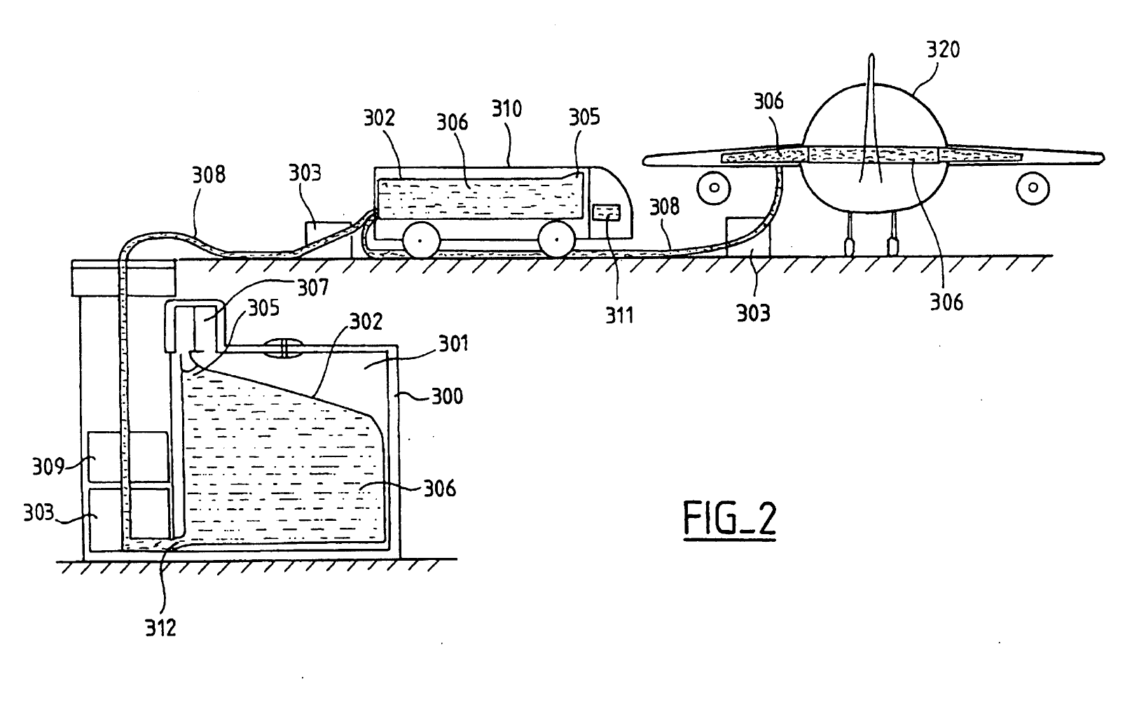

FIG. 2.: Ground Refueling of a Transport Category Airplane

The various reservoirs where the fuel is stored (ground fuel tank, vehicle and aircraft) must be equipped with non-permeable envelopes, flexible or not.

FIG. 2 illustrates the necessity of checking the conformity and stability of the fuel at every step which precedes loading into the airplane's fuel tanks. This is performed in elements 303 of the Device.

The self-oxidation reactions, which took place during previous, perhaps extended, storage periods, at high ambient temperatures and in contact with the air, may have allowed the appearance of hydrogen peroxides or of other oxidizing products, destroying the expected stability of the fuel. In such a case, the fuel should on no account be loaded into the non-permeable envelopes illustrated in FIG. 3, but sent back to the supplier by order from the Flight Captain.

In this figure:

306 is the fuel,

302 is the non-permeable envelope for the fuel,

300 is the structure containing the envelope,

307 is the bubble described below,

305 is the high point of the non-permeable envelope,

308 is the distribution line to the tanker truck 310 and to the airplane 320.

The elements 303 and 309 close to the underground reservoir 302 aimed at controlling (303) the fuel's condition, cleaning and stabilising it (309) if necessary, prior to loading into the underground tank.

Means of control 303 are also planned prior to loading the tanker truck 310, as well as before loading into the aircraft 320.

Reference 311 represents the fuel tank of the truck 310 itself.

FIG. 3: Example of the Device According to the Invention, Adapted to the Central Fuel Tank of a Large Transport Category Airplane, “Retrofitting” (Adaptable to Aircraft in Service)

This embodiment is based on the drawings of the structural design of a transversal bay of the Center Wing Tank CWT) of the Boeing 747 according to the plans provided during the investigation of the TWA 800 mid-air accident just off New York.

200: bay of the central tank.

202, 202₁: envelope containing the fuel.

205: inert gas filling the ullages.

206: fuel.

207: perforated walls isolating the envelopes from the tank walls.

209: “Bubble”.

214: wall of the airbag which encloses an envelope 202.

215: curtain-airbags for the protection of the envelopes from impacts and from and from direct contact with the tank walls.

220, 220₁: inert gas filling the ullages.

221: passenger cabin floor support beams.

222: cabin floor.

223: envelopes' hanging brackets.

224: envelopes' supporting nets.

For this tank, for example, comprising several transversal bays, each one able to contain more than ten tons of fuel, it is possible to consider, for example, installation of eleven envelopes in every bay, each one containing less that one ton of fuel when fully loaded.

Each envelope is placed on a flexible or rigid cradle, made of lightweight material, protecting it from direct contact with the tank floor which is heated by the aircraft's air-conditioning and pressurization units (APU); this cradle, made either of metal, synthetic or composite materials, for example perforated, shall thermally isolate the envelope from the tank floor. Each envelope is further held in place by nets that surround it, keeping it independent from the neighbouring envelopes. These nets, composed for example of synthetic-fibre straps, such as those used on certain airplanes to secure luggage placed in the hold, allow primarily to prevent the envelopes from lateral, longitudinal and vertical slipping in the event of a bumpy flight due to atmospheric turbulence or during landing. Nets also prevent the fuel envelopes from coming into contact with the walls, heated or not, thus leaving a space for curtain-airbags to inflate in order to completely protect each envelope in the event of impact; the ullages around the envelopes are filled with “pure” inert gas. The Device includes means enabling to flush out and fill up these ullages if necessary.

Each envelope is also entirely enclosed by its individual airbag, initially filled with a small quantity of inert gas, such as pure nitrogen or carbon dioxide, enabling it to be deformed while the envelope is being loaded with fuel, maintaining at the same time a thin layer of gas between the two when loading up to maximum capacity. The airbag is inflated with cold, inert/non-reactive gas, activated immediately upon a forced landing impact, especially by a three axis accelerometer.

Should this occur, a pressure sensor, made, for example, from piezoelectric fibres incorporated into its fabric, will automatically stop inflation of the airbag as soon as it has filled up the entire ullage of the tank, the inert gas normally occupying this area having been evacuated via valves/vents (not illustrated), so as to ensure that the tank's structure is not exposed to internal overpressure exceeding the manufacturer's prescribed limit. In the case of the Boeing 747 reservoir, the permitted limit is set approximately to an overpressure of 30% respective to one atmosphere.

The Device also includes some thermal insulation elements (not illustrated) of the reservoir's “heated” walls enabling to reduce or to delay the heating of the fuel inside the envelopes, even if the reservoir is exposed to an outside fire, as can be the case during an emergency landing.

The Device may also include means of activating along the tank walls, between these and the “airbags”, generators of non-flammable retardant foam, filled with an emulsion of inert gas bubbles and having high thermal insulation characteristics. Such foam serves as an additional level of protection to delay the fuel heating up inside the envelopes in the event of a fire startup outside the tank, as well as to delay the “airbags” heating up and, in the end, to slow down the spread of fire, thus providing the necessary respite to organize human and material intervention means to fight and extinguish the fire. It is indeed necessary to delay for as long as possible, any fuel spillage, even minimal, and/or ignition out in the atmosphere or onto the ground near to the airplane so as to give passengers and crew time to evacuate the aircraft and to enable the fire-fighting team to enter into action.

The equipment device for the Boeing 747, partially illustrated in FIG. 3, as an example among others of the consequences of the invention, is intended to be embodied according to the current design of this aircraft. Modifications, not illustrated, to the current fuel distribution systems, to the overflow and to the venting of the tank's ullages of this model and comparable models, particularly from the same manufacturer (Boeing 707, 727, 737, 767), but also from other high-capacity aircraft manufacturers, namely Airbus Industries, should be considered. The dangerous aircraft flying today number several thousand airplanes. Certain initial aircraft structural modifications in the process of design will greatly facilitate the Device's adaptation, not only in terms of lower weight and costs, but also for ease of maintenance.

It should be noted that in the case of FIG. 1, as in the case of FIG. 3, valves 216 and 218 (FIG. 1) are planned, enabling, in the event of accidental impact to the tank (200) or of the heating of its walls due to a neighbouring fire, to separate envelope 202 and airbag 215 which encloses it (214 in the case of FIG. 3) from the vehicle In other words, gates 216 and 218 for loading and emptying are closed in the event of impact or fire and are such that, in this situation, they cause the envelope and the airbag to be disconnected from the tank's structure.

Envelope 202₁ and airbag 220₁ are illustrated after disconnection in FIG. 3.

As non-exhaustive examples, described in FIG. 4 are certain details regarding the “Bubble” element of the device, such element being located in the high point of a confinement envelope, or of an element for storage, transfer, such as a gas or oil pipeline, transportation or handling for fuel, or any other dangerous product:

The figures referenced have the following meaning:

400: envelope wall,

401: air bubbles or those of other gases in suspension,

402: fuel,

403: reservoir or fuel tank ullage,

404: fuel tank or reservoir ceiling,

405: “Bubble”,

406: vapours and gases,

407: droplet catcher, sponge or overflow foam

408: porous flame-arrester,

409: selective extraction membranes, permeable to oxygen in particular, or to other hazardous gases or vapours existing in the tank's ullage,

410: membranes for extracting oxidizers or for introducing inert/non-reactive or neutralizing gas,

411: selective extraction membrane,

412 and 412bis: exhaust orifices towards temporary storage containers for unwanted or hazardous gases and vapours coming from the high point of envelope 406, the sorting being performed by membrane 411,

413 and 413bis: orifices to evacuate the tank's ullage towards temporary storage containers, of the inert gas in the event of overpressure when the “airbag” is suddenly inflated, and of the hazardous gases or vapours possibly detected, once the sorting has been performed by the selective membranes 409 and 410,

414: vapour-cooling atomizer for the reservoir's ullage,

415: hydrocarbon or oxidant vapour-detector for the tank's ullage, measuring means as to their nature, concentration and temperature,

416: valves, for example electromagnetic, closing the orifices of the tank's ullage in the event of accident, being similar to valves 216 and 218 of FIG. 1,

417: reservoir's or fuel tank's ullage loading, emptying or draining valve,

418: closing valve for the envelope and the airbag, diconnectable from the wall in the event of an accident,

420: airbag's wall(s),

421: thermal insulation of the tank's external wall.

The “Bubble” 405 refers to the envelope's 400 safe connection to the environment outside the reservoir. Its role, within the Device, is on the one hand to channel the bubbles of air or of other dissolved or suspended gases, as well as the vapours evaporating from the surface of the product contained in the envelope; it enables to evacuate them towards safe temporary storage containers; it also enables to insert instruments and inert gas inside the envelope and the tank's ullage 403.

This type of bubble for extracting hazardous gases/vapors and or for injecting inert gases may, in another embodiment, be installed at intervals along the gas and oil pipelines in order to eliminate the danger of formation of stagnant explosive atmospheres bubbles/floaters forming therein.

The droplet catcher/sponge/overflow foam (407), positioned at the entrance of the “Bubble”, enables to prevent the product from escaping towards the inner part of the “Bubble”, especially when the envelope is being loaded.

The flame-arrester element 408 fulfills the role of a porous barrier preventing a flame coming from outside the “Bubble” from spreading toward the inner part of the envelope, thus eliminating the risk of ignition, which can be found, in certain cases, probably in an over-oxygenated atmosphere, in its high point 406.

Extraction membranes: several types of selective permeable membranes, active or not, are integrated into the device according to the needs. Some are located inside the “Bubble” (409, 410, 411), as illustrated, in order to enable evacuation of gases-vapors from the high point of the envelope towards appropriate temporary storage containers via exhaust orifices 412 and 412bis, as well as evacuation of the atmosphere existing in the tank's ullage via orifices 413 and 413bis. These membranes can, for example, be in the form of concentric tubing, or even in the form of films, plates, nano-tubing or yet be replaced by sorption/dissolution cartridges. The nature of the stored product and that of the inert gas govern the choice of membranes to be used, adapted to the gases or vapours that need to be separated. A membrane can operate under pressure, either using a pump, or by bleeding the air at, for example, the outlet of the engines' compressors, or extracting the oxygen from the unburnt exhaust gases taken at the outlet of the turbines so as to be able to use these gases as inert gases. These membranes can be a part of the means for cleaning/stabilizing or for the various elements of the device during storage, transfer, transportation or handling of the product, every time it becomes necessary to control its dangerousness and to implement means for extracting the hazardous gases-vapours, such as the oxidizers or other reactants of the product itself. Such membranes can, for example, be an integral part of certain surfaces of an envelope, or be placed in certain elements of the fuel distribution circuit or of the walls of the empty spaces of the fuel tanks or reservoirs.

Introduction membranes: likewise, selective permeable membranes can be used to inject inert, non-reactive gas, such as nitrogen or burnt exhaust gases, or neutralising gases or vapours into the device's empty spaces, for example via valve 417.

In the case of accidental impact, these valves, originally fixed on valves 416, must, after the simultaneous closing of both valves 416-418, be freed from their linkages to the reservoir's wall, namely via frangible bolts, possibly assisted by an impulsion coming from the closing mechanism, in order to allow the “airbag” to protect the envelope's wall from those of the tank. The shape given to the airbag once inflated makes it possible to obtain such result. Such valves have the same role for closing up all the orifices, not illustrated, of the envelope's and reservoir's wall.

Device means and instrumentation according to the invention.

Means for analysis, synthesis, control and intervention, specific to an embodiment of the Device according to the invention, employ in particular, according to the needs, the products and predictable risks, an instrumentation and means adapted to the parameters prescribed by the operator.

The parameters that need to be known and of which the monitoring must be assured in terms of hazards are, in priority, those which enable to permanently control the stability of the concerned product. Such controls are often today rather rudimentary; thus the role of the Device is to carry out such task.

The chemical and physical parameters are measured and monitored throughout the product's industrial journey right up to the time when it is definitely neutralised under control, for example after complete combustion of a fuel mixed with air inside an engine.

A non-exhaustive list of the parameters concerned includes:

Physical parameters: temperatures, pressure, minimum ignition energy, follow-up of chemical or radio-active (isotopes) tracing elements, ionisation, emission and absorption of electromagnetic radiations, product contact time with hazardous reactants.

Chemical parameters: heredity and product danger level, level of hydrogen peroxide content, presence and concentration of free or dissolved oxygen or other oxidizers, disintegration by-products, chemical and biological impurities, existence of hazardous reactants.

The alarm and intervention means triggered off automatically or via manual command from the operator, activated by the Device in the event of an increase of the level of dangerousness are, among others:

Command means and functions: Alarms, gates, valves, pumps, “airbags”, retardant foam generators, atomizers/cooling elements for the product, for detected explosive atmospheres, for the walls of the structures and the elements of the Device, data transmission/reception, recording, fuel/product cleaning, stabilization by injection or extraction, recycling, safe temporary storage, flush out, ventilation, sweeping.

Triggering off intervention means may, in certain cases, be subject to sequences and programmed timeouts (upon prescriptions from the operator).

In the event of impact, valves 416 and 418 shall close shut and such mechanisms as the guillotine, frangible bolts or of the electromagnetic type shall disconnect the envelope and the airbag from the structure.

1. A safety/confinement device for storing, transporting or handling a dangerous and/or potentially-reactive product in an environment of industrial dimensions at essentially ambient atmospheric pressure and temperature, said device comprising:
a reservoir for housing the product therein;
an envelope inside the reservoir, the envelope being designed to protect the product from any contact with atmospheric oxygen, even in the event of rupture of the reservoir structure, and
means to delay or prevent the spillage of said product out into the air, particularly in the event of accidental impact or unforeseen heat exposure from a neighbouring fire.

2. The device of claim 1, comprising at least one permeable membrane capable of selective sorption, dissolution or diffusion to enable the extraction of potentially hazardous vapors and gases contained in at least one element of the device.

3. The device of claim 1, comprising at least one selective permeable membrane to enable injection of an inhibitor/stabilizer into the product or into its vapors, or of an inert gas used to flush out and/or ventilate empty spaces of the reservoir and other elements of said device.

4. The device of claim 1, comprising means for generating and for injecting into the reservoir, around an envelope containing the product and/or around at least one inflatable cushion of the “airbag” type or around another component, of fire-retardant foam, self-solidifying or not, incombustible and inert with regard to the stored product, contributing towards protecting the envelope and making it leak-proof, by physically and thermally shielding the product from the walls and from the surroundings.

5. The device of claim 1, comprising at least one safety valve controlling the product inlet and/or outlet from an element of said device or the entry of ambient air in the event of failure of the distribution system or rupture of its outside connection.

6. The device of claim 1, comprising an element equipped with at least one mechanism located at one of the inlets and/or the outlets of an envelope containing the stored product to close the orifices of the envelope by sealing them shut, as well as those of an inflatable cushion of the “airbag” type enclosing it, while freeing them loose from the walls of the reservoir.

7. The device of claim 1, wherein at least one of the elements containing the product comprises an impermeable envelope, deformable or not, containing the product.

8. The device of claim 7, wherein the envelope in which is contained the dangerous product comprises an element which displays at least one of the characteristics selected from the group comprising:
being impermeable and chemically inert, especially with respect to the stored product, to its vapours, and to its self-reaction, decomposition and/or degradation by-products, to the chemical or biological impurities which it may contain, to the air or to another ambient reagent, the envelope preferably including one or several layers of various, appropriate non-permeable materials,
being impact-resistant mechanically, to perforation and/or to tearing, for example by being made of two or more layers of material in which are eventually incorporated mesh or fibres of “nylon”, glass, carbon, “Kevlar”, metallic and/or synthetic, woven or not,
tolerating temperatures varying from minus 50 degrees Celsius to plus 900 degrees Celsius, preferably from minus 50 to plus 150 degrees Celsius, and
being relatively insensitive to to solar radiation, especially for cases where the envelope is liable to be exposed to them for long periods, for example when it contains a product stored in bulk.

9. The device according to claim 8, including micro and/or nano sensors to detect the envelope's condition and characteristics, notably of an autonomous wireless type or connected for instance by optical fibre(s) to a control, monitoring and command centre for activating means of intervention of the device.

10. The device according to claim 7, wherein that the envelope is itself completely enclosed by at least one inflatable watertight cushion of the “airbag” type.

11. The device according to claim 10, wherein the inflating of at least one component of the “airbag” type, at the time of its activation, is ensured via an inert and incombustible gas, such as nitrogen or argon for fuels, especially non-reactive in relation to the stored product and to its decomposition products.

12. The device of claim 1, comprising means to control the stability and/or the initial reactivity of the product, to ensure continual monitoring of its dangerousness, especially its composition, its age, its aging rate and such parameters as its temperature and the concentration of the most significant reagents, in order to activate, manually or automatically, using predetermined values, alarm and intervention means, such means of intervention especially enabling to correct, as needed, the physical or chemical parameters required to avoid an uncontrollable runaway reaction.

13. The device of claim 1, wherein the reactive or dangerous product contained within includes at least one of the products selected from the group comprising: fuels, especially hydrocarbons, carbohydrates and hydrogen, organic materials, oxidizing agents, especially oxygen and peroxides, chemical substances liable to ignite/explode spontaneously when brought into contact with ambient air, or products of a toxic and/or polluting nature for the ambient environment.

14. The device of claim 1, comprising means to ensure several levels of confinement adapted to the product or to the risks of accidental aggression linked to the environment or the conditions of use, such means preferably including the successive elements surrounding an envelope containing the product, the layers of which each provides an added level of chemical, physical, thermal and/or mechanical protection to the dangerous product contained within, in addition to the envelope.

15. The device of claim 1, including at least one detector and/or a sensor, and/or a detector that is part of a microcomputer, having the task of transmitting data to a central processing unit or to a control centre, especially via wireless liaison and/or via fibre optics.

16. The device of claim 1, including means of intervention capable of being implemented in accordance with the data transmitted by the detectors or sensors, and/or the sensors that are a part of a microcomputer, in order to overcome the risks incurred.

17. The device of claim 1, including at least a means for recovering gases, reactive and/or toxic substances, flammable vapours of a hazardous, toxic and/or polluting nature, extracted from an element of the device, especially from the envelope, in order to temporarily store them safely, condense, recycle or neutralize them, should there be a risk of self-ignition or explosion or of accidental release into the environment.

18. The device of claim 1, wherein the envelope has at least one high point so that bubbles, vapours or gases present in the stored product tend to accumulate in such a high point.

19. The device of claim 1, including means for evacuating the gases and/or the accumulated vapours, especially in a high point of an envelope or of a product transfer/distribution element, in order to, for example, collect them, direct them to safe storage, stabilize them, neutralize or burn them in a controlled manner, for example in a motor or a flare, or to reinject them back into the product or into a distribution circuit.

20. The device of claim 1, comprising means to at least carry out one of the following operations:
monitor the product's temperature and compare it with at least one value set by the operator,
cool the product to the prescribed level needed to ensure that the safety margin imposed relative to the ambient risk of an accidental energy influx exceeding the amount required for self-ignition/explosion,
control the stability of the product,
detect the presence of hazardous vapours, especially flammable and/or explosive, in the elements of the device located outside an envelope containing the product, and evaluate their danger according to their temperature and their concentration, along with those of the oxygen and/or other reagents, and
compare the measured values with the pre-determined values in order the open or to close at least one valve or one gate and/or to particularly activate means for filling/emptying, for inflating, for flushing out, for ventilating, for injecting neutralising products, for cooling off and for collecting.

21. The device of claim 1, comprising means to at least carry out one of the following operations:
detecting an impact,
identifying a leakage of the product contained in the envelope,
detecting and measuring an increase in the temperature of the product, and/or of the walls of the reservoir and of those of any other element(s) of the device,
monitoring the duration of storage of the product and the conditions under which it is stored, and comparing the said duration with a deadline eventually prescribed by the operator,
evaluating its level and/or its rate of aging.

22. The device of claim 1, comprising at least one sensor such as piezoelectric fibres included in the wall of a component of the “airbag” type, and means such as a valve, in order to prevent the “airbag” type component from inflating to a pressure exceeding the specifications of the reservoir's structures, and then preventing it from deflating once the desired volume has been reached in order to ensure optimal protection of an envelope containing the product as well as of the stored product.

23. An application of the device of claim 1 to a land, air, space, maritime or river vehicle.

24. An application of the device of claim 1 to storage, to transfer, to transport, to handling bulk products, packed or not, and/or in an open space, or a confined or semi-confined reservoir.

25. Application of the device of claim 1 to storage, to transfer, to transport or to handling a product that is in gas or liquid form, especially vapours, mist, droplets or solids, for example as particles, grains, granules, powder, dust, flour, chips, fibres, sheets or porous material.
